(19) United States
(12) Patent Application Publication
(10) Pub. No.: US 2012/0054679 A1
(43) Pub. Date: Mar. 1, 2012

(54) Menuing Structure for Favorite Media Content

(75) Inventors: Jeffrey Ma, Emerald Hills, CA (US); Elbert D. Chen, Cupertinmo, CA (US); Jeffrey Robbin, Los Altos, CA (US); Calin Pacurariu, Los Gatos, CA (US); William Martin Bachman, San Jose, CA (US); James A. Young, Livermore, CA (US)

(73) Assignee: APPLE INC., Cupertino, CA (US)

(21) Appl. No.: 13/108,934

(22) Filed: May 16, 2011

Related U.S. Application Data
(60) Provisional application No. 61/378,883, filed on Aug. 31, 2010.

(51) Int. Cl. G06F 3/048

(52) U.S. Cl. 715/810

(57) ABSTRACT

Technologies for generating a menu of favorite media items for presentation to a user are described. In one aspect, input from a user designating a show as a favorite show is received. In response to receiving the input, show information relating to the favorite show is displayed in a first graphical user interface. The show information includes a plurality of shortcuts, each shortcut pointing to a corresponding episode of the favorite show, and indicia displayed concurrently with the shortcuts to mark unwatched episodes. In response to receiving the input, a pointer associated with the favorite show is displayed in a second graphical user interface. The pointer points to the show information displayed in the first graphical user interface, such that the pointer associated with the favorite show is being displayed in the second graphical user interface concurrently with shortcuts associated with one or more other favorite shows.

### CLAIM OF PRIORITY

This application claims priority under 35 USC §119(e) to U.S. Patent Application Ser. No. 61/378,883, filed on Aug. 31, 2010, the entire contents of which are hereby incorporated by reference.

### BACKGROUND

This disclosure relates to a menuing structure for presenting favorite items of media content (e.g., video, audio, still images) that are available on a media device.

Generally speaking, a media device, also known as a digital media receiver or digital media adapter, is a special purpose computer system that can connect to a packet-switched network to retrieve digital media files or streams (such as music, pictures or video) from a personal computer or other media server and play them back on a home theater system or TV. As media devices and online providers of media content have become more prevalent, the choices of media types and selection of particular media items have grown considerably and will continue to do so. Manufacturers of media devices strive to present this vast array of available media choices to a viewer in a meaningful way.

### SUMMARY

Among other things, the disclosed media menuing structure enables the presentation of multiple different types of media (e.g., movies, TV shows, music, photos, podcasts and websites) in a user-friendly and intuitive manner. For instance, the disclosed technologies can be used to generate a menu of favorite shows for presentation to a user of a media device. The favorites menu can be used in conjunction with one or more show menus with which the user can interact to browse and select episodes of a favorite TV show for playback.

In one aspect, the subject matter described in this specification can be implemented as a method including receiving input from a user designating a show as a favorite show. The show designated as a favorite show can have multiple episodes. Further, the method includes, in response to receiving the input, displaying show information relating to the favorite show in a first graphical user interface. The show information includes (i) a plurality of shortcuts, each shortcut pointing to a corresponding episode of the favorite show, and (ii) indicia displayed concurrently with the shortcuts to mark unwatched episodes. Furthermore, the method includes, in response to receiving the input, displaying a pointer associated with the favorite show in a second graphical user interface. The pointer points to the show information displayed in the first graphical user interface, such that the pointer associated with the favorite show is being displayed in the second graphical user interface concurrently with shortcuts associated with one or more other favorite shows.

Optionally, the method may include one or more of the following aspects. The input from the user can be received via the first graphical user interface. In some implementations, the method also includes displaying, in the second graphical user interface concurrently with the pointer associated with the favorite show that points to the show information displayed in the first graphical user interface, an indicator associated with the pointer to indicate a number of unwatched episodes from among the multiple episodes of the favorite show. For example, an indicium, which is displayed in the first graphical user interface concurrently with a shortcut pointing to an unwatched episode, at least partially overlaps the shortcut. In another example, the indicator, which is displayed in the second graphical user interface concurrently with the pointer associated with the favorite show that points to the show information displayed in the first graphical user interface, at least partially overlaps the pointer.

In addition, an indicium, which is concurrently displayed in the first graphical user interface with a shortcut pointing to an unwatched episode, can be filled with a color to indicate that the unwatched episode is completely unwatched. The indicium can be partially filled with the color to indicate that the unwatched episode is partially watched but not completed.

In some implementations, a shortcut pointing to an episode is represented in the first graphical user interface by at least an image associated with the episode, and a pointer pointing to the show information is represented in the second graphical user interface by at least an image associated with the show. For example, the image associated with the show, which is used to represent in the second graphical user interface the pointer pointing to the show information displayed in the first graphical user interface, is an image associated with one of a first or a most recent episode of the favorite show.

In some implementations, the method can include receiving, in the second graphical user interface, user input indicating that the user wishes to change a current position of the pointer associated with the favorite show. In response to receiving the user input, the method can include jiggling at least the pointer associated with the favorite show at the current position to indicate to the user that the current position of the pointer can be changed. Further, the method can include receiving, in the second graphical user interface concurrently with jiggling the pointer, another user input including at least an indication of a new position for the pointer associated with the favorite show. In addition, the method can include rearranging the pointer associated with the favorite show and the pointers associated with the other favorite shows in accordance with the received indication of the new position for the pointer associated with the favorite show.

Other implementations of this aspect include corresponding computer systems, apparatus, and computer programs recorded on one or more computer storage devices, each configured to perform the actions of the method. A system of one or more computers can be so configured by virtue of software, firmware, hardware, or a combination of them installed on the system that in operation cause the system to perform the actions. One or more computer programs can be so configured by virtue having instructions that, when executed by data processing apparatus, cause the apparatus to perform the actions.

The subject matter described in this document can be implemented to realize one or more of the following potential advantages. For example, a media menuing structure can be implemented that makes intelligent choices about the media content items most likely to be of interest to a user. Those media items, which tend to be the newest and freshest items of media content, are displayed and made available to the user in a prominent location within the menu structure, thereby facilitating ease of access and increasing the likelihood that they will be noticed by the user. As another example, a favorites menu can be configured to be used in conjunction with one or more TV series menus with which the user can interact to browse and select episodes of a favorite TV series for playback.

The details of one or more implementations are set forth in the accompanying drawings and the description below. Other features and potential advantages will be apparent from the description and drawings, and from the claims.

### BRIEF DESCRIPTION OF THE DRAWINGS

FIG. 1 is an example of a media system including a media client.

FIGS. 2-5 are screenshots of a menuing system for displaying media content choices to a user.

FIG. 5B is a screen shot of a favorites menu for displaying favorite media content to a user.

FIG. 5C is a screen shot of a season screen for displaying episodes of a selected TV series to a user.

FIG. 6 is a flowchart of a process for generating a menu of available media items for presentation to a user.

FIG. 6B is a flowchart of a process for generating a menu of favorite media items for presentation to a user.

FIG. 7 is an example of a media client architecture.

Like reference symbols indicate like elements throughout the specification and drawings.

### DETAILED DESCRIPTION

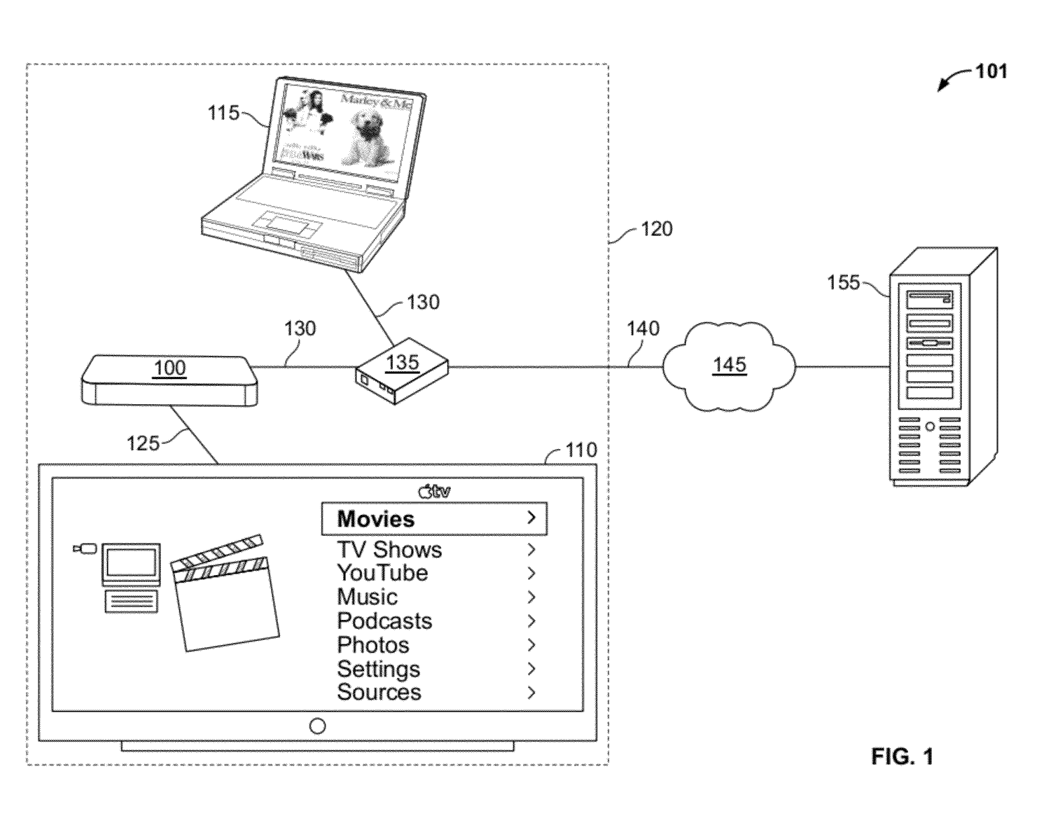

FIG. 1 shows a media system 101 that includes a media client 100, such as an Apple TV device, which can be configured to present media content, including movies, TV shows, music, photos, podcasts and websites, video, and to provide a user interface with a menuing structure that facilitates the navigation and selection of media item choices. The media system 101 includes a client location 120, such as a home or office, in which the media client 100 resides. The client location 120 also can include a local media server 115, such as a notebook computer executing an appropriate software application (e.g., iTunes), and a presentation device, such as a TV set or monitor 110. The monitor 110 can be coupled to the media client 100 through a media connector 125, such that video and/or audio information output by the media client 100 can be presented through the monitor 110. Further, the media client 100 can be coupled to the local media server 115 through a local connection 130, such as either a wired or wireless network connection. As such, the media client 100 can receive media content from the local media server 115. The local media server 115 can be any suitable computing device, including a notebook or desktop computer, a server, a handheld device, or a media device capable of storing and/or playing back media content.

Further, the client location 120 can have a network connection 140 that provides access, via modem (or other network access device) 135 to a network 145, such as the Internet or another packet-switched network. By virtue of the network connection 140, the media client 100 and/or the local media server 115 can be configured to access media content from essentially any suitable media content provider connected to network 145, including for example a media store 155 such as the iTunes Store, from which a user can obtain media content.

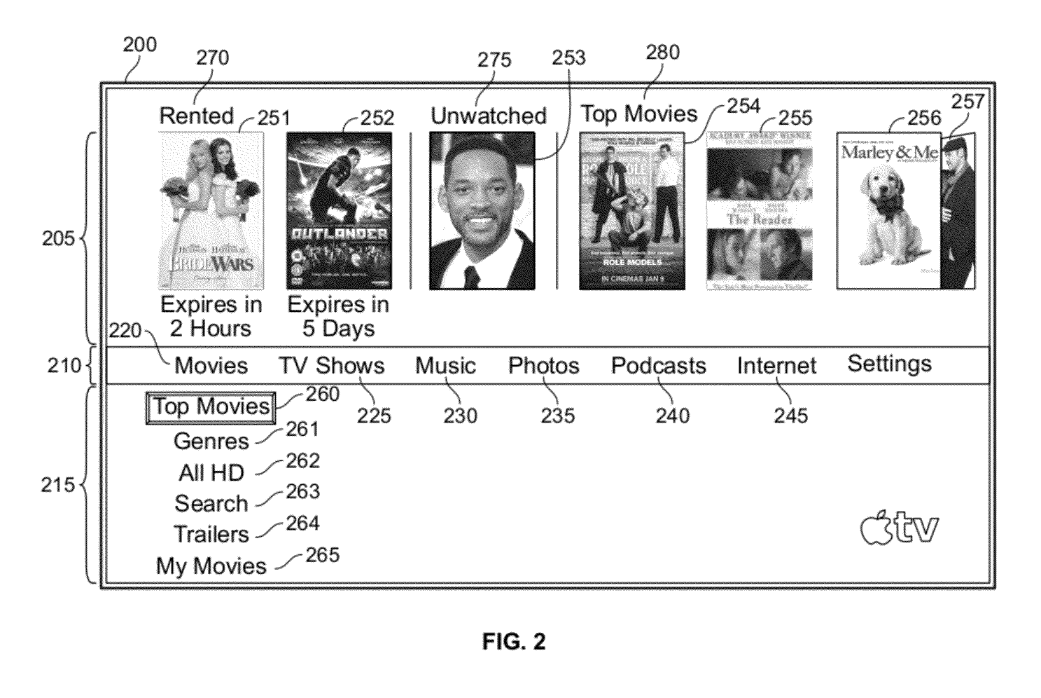

FIG. 2 depicts an example screen shot of a top-level media menu 200 with which a user of the media device 100 can interact to browse and select items of media content for playback. The menu 200 includes 3 different regions including a shelf region 205 for displaying individual items of media content, a media type category region 210, which includes names of different media type categories (as shown Movies 220, TV Shows 225, Music 230, Photos 235, Podcasts 240, Internet 245), and a sub-category region 215, in which sub-category menu options are displayed for each associated media type category.

The media device user typically interacts with the media device by means of a wireless remote control device (not shown), which the user can manipulate to move the cursor focus among the different selectable menu items. As depicted in FIG. 2, the user has manipulated the remote control to place the focus on “Top Movies” 260, the topmost sub-category choice under the Movies category 220. As used herein, the term “Top Movies” refers to movies that, according to some metric, have been deemed by a third party entity (e.g., the entity that operates the media store 155) to be the best, most popular or otherwise superlative. If at this point, the user were to select the Top Movies sub-category 260, e.g., by clicking a button on the remote control, the media device would respond by displaying an entirely different menu screen related to Top Movies. On the other hand, if the user did not select Top Movies 260 but rather manipulated the remote control to move the focus vertically downward, the screen display would remain essentially identical as shown in FIG. 2 except that the visual indication of the current focus would be re-displayed to be on Genres 261. In this manner, the user can manipulate the cursor up and/or down within the same vertical column to select among the various sub-category menu choices. In general, selection of any of these sub-category menu choices would result in the media device 100 changing the screen to display a different menu associated with the selected sub-category choice.

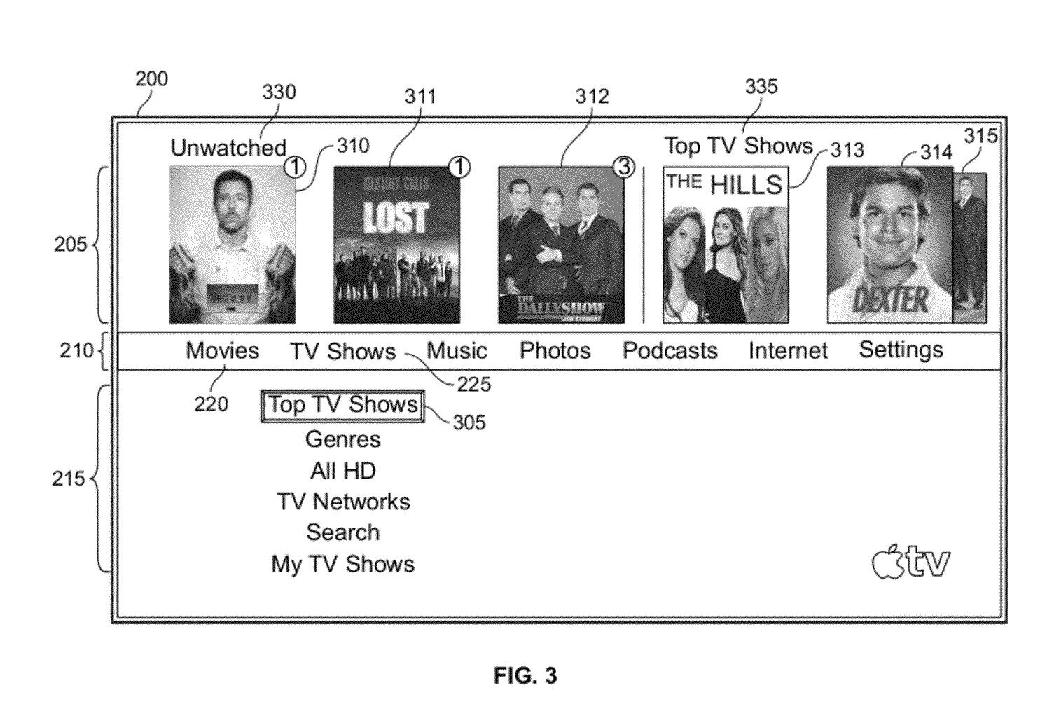

If, however, the user manipulates the remote control to move the focus horizontally right at the moment in shown in FIG. 2, regardless of which Movies sub-category happened to be the current focus, the focus would change to the TV Shows category 225 and, as shown in FIG. 3, the sub-category menu choices for the TV Shows category 225 would be displayed (and concurrently the Movies sub-categories menu choices would disappear from view since the Movies category 220 was no longer the focus). When changing the focus from one media type category to another (e.g., from Movies 220 to TV Shows 225), the particular sub-category menu choice that receives the focus is the sub-category menu choice that had the focus the last time the user left that media type category. In FIG. 3, the focus was received by Top TV Shows 305, indicating that the last time the user was visiting the TV Shows category 22, the Top TV Shows sub-category 305 had the focus at the moment when the user moved the focus left or right to choose a new media type category. Either that or the media device 100 is brand new or has been re-booted or re-set, in which case the uppermost sub-category menu choice becomes the default to receive the focus.

As described above, the user can manipulate the remote control to move the focus left and right to select different media type categories and/or up and down to select among the different sub-category menu choices relating to the currently selected media type category. If, however, the focus is at the topmost sub-category menu choice and the user moves the focus upwards from there, the focus jumps into the shelf region 205, and lands on one of the individual items of media content displayed therein. (The region 210 is solely for display purposes and is not configured to receive the focus.) As with moving from one media type category to another, when moving into the shelf region 205, the focus is received by the particular media content that last had the focus before the user moved to a new media type category or, in the case of a new or re-started media device 100, the focus is received by default on the leftmost item of media content on the shelf 205.

Once in the shelf region, the user can move the focus down again to re-enter the subcategory menu region 215 for the currently active media type. In addition, the user can move the focus left and right to select among the various items displayed along the shelf 205. The media item displayed leftmost (e.g., item 310 in FIG. 3) on the shelf region 205 represents a stopping point beyond which the focus can travel no further in that direction. At the rightmost side of the shelf region, however, once the focus has reached the farthest right displayed media item (e.g., item 315 in FIG. 3), the user can still move the focus farther right to access the next, yet presently unseen item of media content. As the focus keeps moving to the right, the shelf display changes, effectively scrolling to the left (meaning leftmost items become no longer visible) to accommodate previously undisplayed items to scroll onto the shelf 205 and into view. An implementation of such scrolling behavior is known as “Cover Flow.”

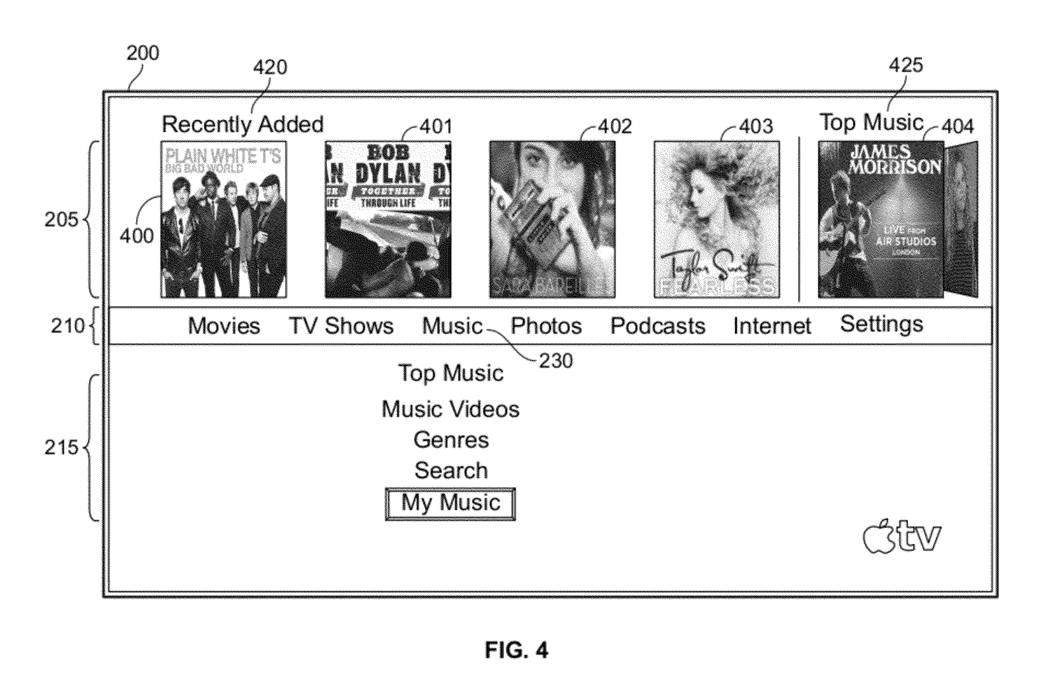

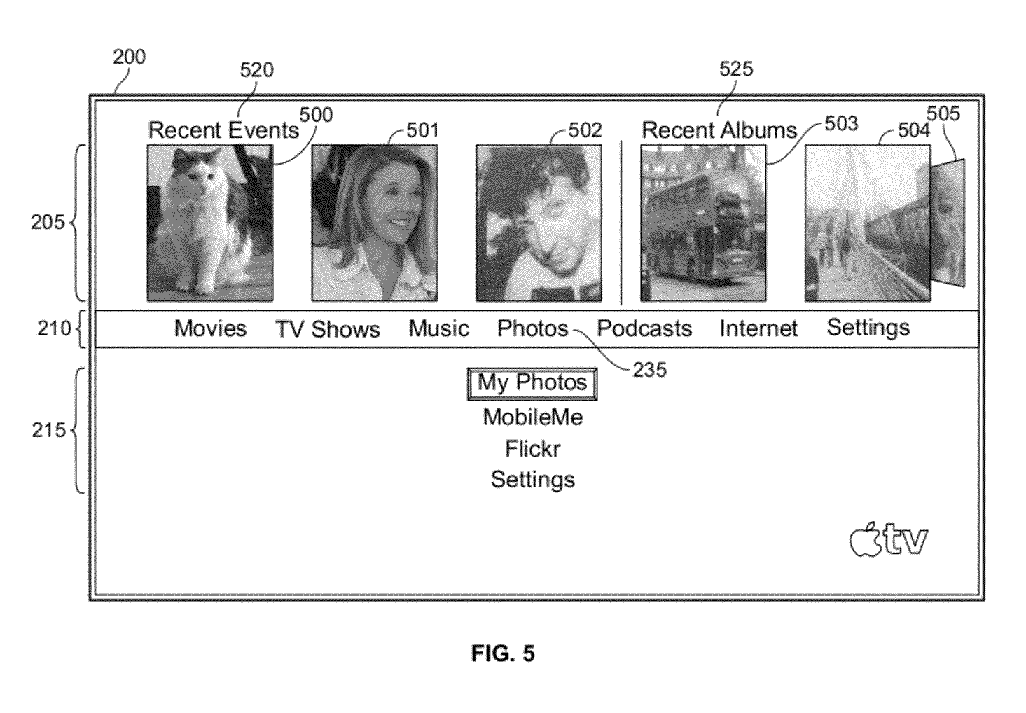

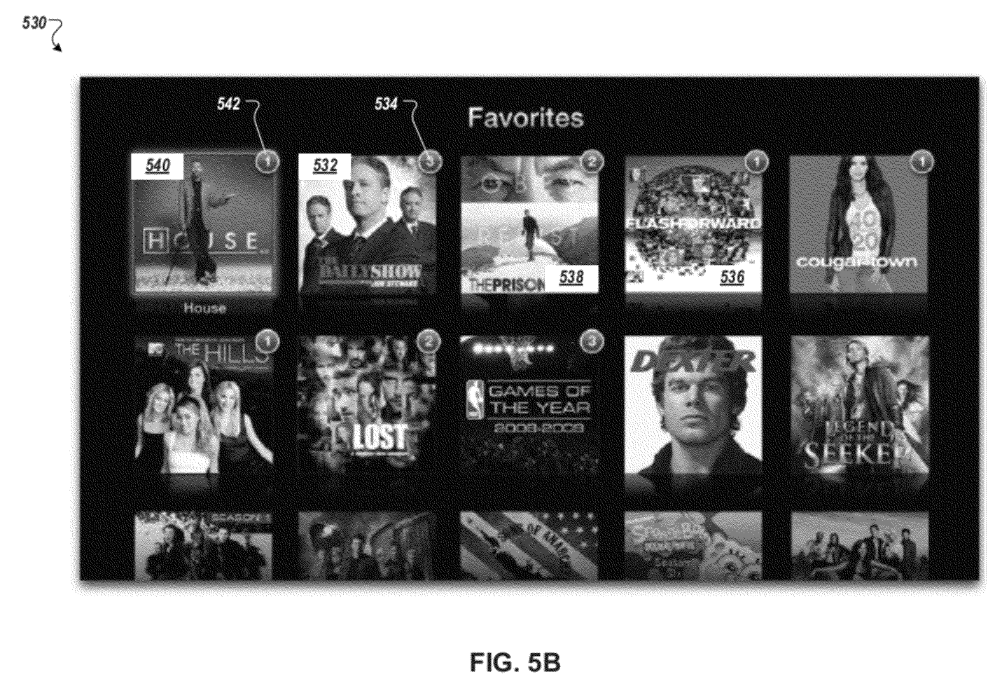

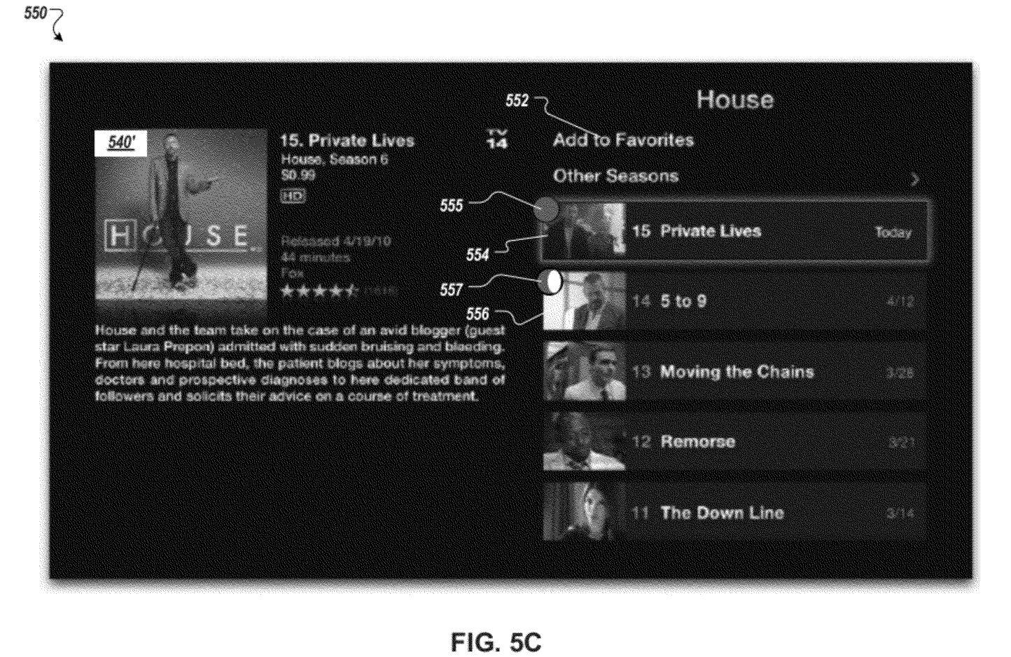

As can be seen by comparing FIGS. 2-5, the particular items of media content displayed in the shelf 205 change in response to a change of the media type category. For example, comparing FIGS. 2 and 3, before the user changes the focus from Movies 220 the individual items of media content displayed in the shelf 205 are movies, in this example, seven different movies 251-257 are visible in the shelf 205 as shown in FIG. 2. In contrast, as soon as the user changes the focus to TV Shows 225, the shelf display changes to display individual items of media content corresponding to TV Shows as shown in FIG. 3. Similarly, the media content items displayed on the shelf 205 change to six items of music media content 400-405 (specifically, albums) when in the Music category 230 as shown in FIG. 4, to six items of photo media content 500-505 when in the Photos category 235 as shown in FIG. 5, and to items of Podcast media content when in the Podcasts 240 category (not shown).

An inspection of FIGS. 2-5 also shows that, in addition to changing the items displayed on the shelf 205 in response to changing media type category, the particular media items displayed are separated into different groups or groupings, which also can vary based on media type category. For example, when in the Movies category 220, the media items displayed on the shelf 205 are separated into three different groupings as indicated by descriptive indicia, specifically by displaying the group headings “Rented” 270, “Unwatched” 275 and “Top Movies” 280. As seen in FIGS. 3-5, other media type categories can be grouped for display on the shelf 205 under different grouping criteria. For example, as shown in FIG. 3, the individual items of TV show media content 310-315 also are divided into three different groupings, “Rented” (not shown), “Unwatched” 330 and “Top TV Shows.” As shown in FIG. 4, media items on the shelf 205 while in Music 230 are grouped into “Recently Added” 420 and “Top Music” 425. When in the Photos category 235 as shown in FIG. 5, the shelf items are grouped in “Recent Events” 520 and “Recent Albums” 525.

Depending on a system designer's objectives, additional or different shelf groupings of media items can be used as desired. In an implementation of a media menu, shelf groupings can be designed to help ensure that a predicted optimal choice of content is made available to the user via the shelf region 205, which holds a prominent position in the menu 200 and thus makes user access to the identified optimal choices quick, easy and intuitive.

The predicted optimal choices can vary with the media category type. For example, in the Movies category, the user likely will want to watch movies that he or she has not yet watched (or not completed watching) but has previously taken actions that suggest that he or she wants to watch them. In the case of movies, if the user has previously rented or purchased a movie, it is reasonable to assume that the user will want to watch the rented or purchase movie in the relatively near future. Accordingly, the shelf groupings depicted in FIG. 2, namely, Rented 270 in this context indicates a movie that has been rented from the media store but not yet completely watched or not yet expired) and Unwatched 275 (which indicates a movie that was purchased from the media store but not yet completely watched), were designed to further these assumptions by identifying unwatched movies that have been rented or purchased by the user and then displaying these prominently on the shelf.

The shelf groupings used for a particular media category can have priorities relative to each other, which are used by the media device to make decisions about which individual media items to display. For example, as shown in FIG. 2, the Rented grouping 270 has a higher priority than either the Unwatched grouping 275 or the Top Movies grouping 280, and thus is displayed before (i.e., to the left of, based on the reading direction of western hemisphere languages) either of those grouping. The rationale for doing so is that rented movies necessarily expire and thus have a higher degree of urgency to be watched before they do so. Using this same logic, rented movies with the shortest expiration time are displayed before (to the left of) rented movies with longer expiration times. Purchased movies, which in contrast, do not expire and thus have a lower degree of urgency to be watched, have a lower priority than rented movies and thus are displayed on the shelf after (to the right of) rented movies.

As shown in FIG. 3, the shelf groupings for the TV Shows category are similar to those for movies, in that TV series with unwatched episodes fall within a grouping (Unwatched 330) that is displayed first (leftmost), meaning that this grouping has the highest priority for TV Shows media. Similarly, shelf groupings for the Music media type category 230 give highest priority to the newest music media items. As shown in FIG. 4, the grouping 420 “Recently Added” is given the highest priority and thus is displayed leftmost on the shelf 205 while in the Music media type category. Music items within that grouping also are prioritized relative to each other based on newness to the user, which the most recently added music item 400 being displayed leftmost within the grouping 420.

The groupings used in the Photos media type category also are designed to give highest priority to the newest or freshest items of photo content. As shown in FIG. 5, the “Recent Events” grouping 520 has the highest priority, and thus is displayed to the left of “Recent Albums” 525. As with other groupings, individual items within either of these groupings can be prioritized and positioned within the grouping accordingly. Although not shown in a figure, the shelf groupings used for the Podcasts media type category also can be implemented based on giving the newest or freshest content the highest priority. For example, an “Unplayed” grouping (referring to un-listened-to or un-watched episodes of podcasts to which the user had previously subscribed) could be given the highest priority and thus displayed leftmost on the shelf while in the Podcasts media type category 240.

In contrast, in the Internet category 245—which refers to websites or other resources on the Internet that provide streaming audio and/or video feeds (e.g., Internet radio stations are an example of the former and Youtube is an example of the latter)—shelf groupings and prioritizations need not necessarily focus on the newest or freshest content. For example, an assumption can be made that, in the case of Internet radio stations, users tend to find a few favorites and then stick with them, at least temporarily, meaning that they would like to listen to one or more of the same Internet radio stations that they listened to the last time they listened to Internet radio. Accordingly, a shelf grouping based on the last few (e.g., 3) radio stations accessed by the user could be used and given priority. In that case, when a user selected the Internet category 245, the shelf could be displayed with a leftmost grouping named “Recent Radio” that listed the last three Internet radio stations that the user accessed.

Alternatively, or in addition, the Internet category (or, for that matter, any of the aforementioned media type categories) could specify a “Now Playing” shelf grouping and give it highest priority, meaning that the particular item of media content currently being played back would be displayed leftmost on the shelf under the grouping “Now Playing.” Still further, other shelf groupings can be developed and used (and given suitable priorities) for special case situations, to emphasize specific online resources or services that might be of interest to the user. For example, certain online media sharing websites and/or mobile device access services might warrant special shelf groupings and priorities.

Another type of shelf grouping that can be used relates to using shelf space for marketing or advertising purposes. As shown in FIGS. 2-5, the shelf groupings Top Movies 280, Top TV Shows 335, and Top Music 425 are examples of advertising groupings. In some implementations, the advertising groupings can be based on one or more predetermined sets of rules. For example, in the case of Top Movies, the first N number of top movie rentals can be included in the advertising grouping. Typically, these groupings are given a very low or the lowest priority, meaning that they are the first to disappear from view whenever a shelf space shortage or conflict arises. In general, such advertising grouping are displayed on the shelf only when the user does not have any (or much) of his or her own content available. The rationale behind advertising groupings is that there represent a good use of shelf space that would otherwise go empty. In addition, full media shelves, even if full with media content that the user does not yet possess or have access to, tend to have a better visual appearance than empty shelves.

More generally, different shelf groupings could be used if different assumptions were made and/or if different objectives were sought to be realized. For example, one possible assumption is that a person would most likely want to listen to a song that he or she had been listening to frequently as of late. Accordingly, in a different implementation, a “Most Frequently Played” grouping and prioritization could be implemented for music media in which songs that the user had played the most (either in a recent window of time or historically) could be given the highest or a relatively high priority within the music media type, and thus songs that the user had played a lot would tend to be displayed leftmost on the shelf while in the Music media type category. In general, the different kinds of groupings and prioritizations for those groupings are limited only by the creativity of the system implementer. Another possible implementation, would be to allow users to choose their own groupings and/or priorities for any given media type, either by selecting from a list of pre-defined groupings, or by enabling users to construct their own.

As shown in FIGS. 2-5, the shelf can reasonably display only a limited number of media items at any given time. For example, while in the Movies category, seven different individual movies 251-257 are visible at one time, whereas the media categories TV Shows 225, Music 230, and Photos 235 each display six media content items on their respective shelves. Accordingly, to take into account the limited shelf space, certain display rules can be applied that affect parameters such as which groupings are displayed, how many media items are displayed in each grouping and in what order, and what should be displayed if empty space on the shelf needs to be filed and/or if the media device 100 has no active Internet connection or if the media store 155 is unavailable. An underlying rationale here is to make wise use of limited shelf space in a manner that enables all shelf groupings, or at least the more important shelf groupings, to occupy at least some visible shelf space while not crowding out the others, thereby making a selection of media items that span two or more groupings readily available and easily accessible to the user. At the same time, the shelf should, whenever possible, be displayed as full of available items.

Accordingly, a set of such shelf display rules can be as follows:

Shelf Display Rules
Higher priority shelf groupings are displayed before (i.e., to the left of) lower priority groupings
Within a shelf grouping, higher priority media items are displayed before (i.e., to the left of) lower priority media items
Except as otherwise provided, groupings related to newer, fresher, not-yet-played-back or more emergent media content items (e.g., content items about to expire and no longer be available) have a higher priority than older or previously played back media items
Except as otherwise provided, no grouping shall display more than three media items at a given time
If a grouping has no corresponding items of media content, then that grouping is not displayed and the next highest priority grouping takes its place
The rightmost shelf grouping (i.e., the displayed shelf grouping with the lowest priority) provides access to all of its media items (or up to a certain quantity, e.g., 25) by means of a Cover Flow or scrolling display effect
The shelf must have a minimum quantity of media items displayed, the minimum varying according to media type
If an insufficient quantity of media items are available to display on the shelf to meet the shelf media-type specific minimum quantity, then the maximum number of media items to be displayed per group for the highest priority group is raised until the shelf minimum is satisfied. If the highest priority group does not have enough extra media items to display to satisfy the shelf minimum, then the maximum per-group number of media items for the next highest shelf grouping is raised, and so on with decreasing shelf group priority, until the shelf minimum is satisfied.
The advertising groupings have the second lowest priorities and are displayed only if the other groupings in that media type do not have sufficient media items to fill the shelves
The lowest priority shelf groupings are the “Recent” groupings (referring to recently played or otherwise accessed media residing on the user's media device; each of the Movies, TV Shows, Music, Photos and Podcasts media categories can have a “Recent” grouping). If shelf space needs to be filled and the Advertising groupings are not available (e.g., due to lack of Internet connection or other lack of ability to access the media store), then media items from the “Recent” groupings will be used to fill the shelf to its required minimum. An alternative rule can include prioritizing “recent” groupings over Advertising groupings for selected categories. For example, recent radio stations can be prioritized higher than Advertising groupings for radio stations, while for all other groupings, “Recent” groupings receive a lower priority than Advertising groupings.
If all else fails (i.e., all of the rules above are implemented but there still are not enough media items to satisfy the shelf's minimum), display empty media containers (e.g., blank boxes) and/or display a notification (“Not Connected to Internet” or “No media store available”), as appropriate.

As with the grouping definitions, different or additional shelf display rules can be used depending on design objectives.

FIG. 5B depicts an example screen shot of a favorites menu 530 with which a user of the media device 100 (shown in FIG. 1) can interact to browse and select items of media content for playback. A user can create shortcuts (pointers) to point to his or her favorite media items (e.g., favorite TV shows) by adding them to the favorites menu 530. For example, a user can indicate one or more TV series as favorite TV series. The section below describes the favorites menu 530 with respect to TV episodes, but the teachings therein can also apply to other media types, such as movies, songs, podcasts, etc.

As new episodes of a TV series indicated as a favorite TV series become available, the TV series can be marked with an indicator to indicate that new episodes are available. For example, a TV series 532 can be included in the favorites menu 530. An indicator 534 can be placed over or near the image representing the TV series 532 to indicate that new episodes are available. In some implementations, the indicator 534 can indicate the number of new episodes available. For example, the indicator 534 can indicate the number of unwatched and/or partially watched episodes from the current season of the TV series 532. In the example shown, the indicator 534 indicates that there are three new episodes of the TV series 532 available to be viewed. As another example, the indicator 534 can indicate a number of episodes of a TV series that are available to purchase or rent that have not yet been purchased or rented by a user.

In some implementations, the indicator 534 will only indicate the number of new episodes for a current season and unwatched episodes from past season will not be included in the number displayed by the indicator 534. In some implementations, rented TV episodes can be marked with an indicator if they are still available to be viewed. In some implementations, an indicator used to mark a rented TV episode (or movie, song, podcast, etc.) can be different from an indicator used to mark a purchased TV episode (or movie, song, podcast, etc.).

TV series (or other media) displayed in the favorites menu 530 can be sorted in multiple ways as described above for the top-level media menu 200. In some implementations, the media items/TV series included in the favorites menu 530 can be sorted by date, by alphabetical order, or in the order the media items/TV series were added to the favorites menu. For example, TV series can be displayed in alphabetical order by series title. In some implementations, newly added shows are added to the end of the grid displayed in the favorites menu 530. In some implementations, a user is allowed to specify a sorting order for displaying the TV series within the favorites menu 530.

In some implementations, a user can reorder the TV series displayed in the favorites menu 530 by selecting an image representing a TV series, and changing the position of the TV series. For example, the user can highlight an image representing a TV series 536. The user can then hold down a select control button to indicate that the user wishes to change the position of the TV series 536. For example, the favorites menu 530 can indicate that the TV series 536 can be moved by causing the images representing the TV series displayed by the favorites menu 530 to “jiggle.” As another example, only the image representing the selected TV series will jiggle. The user can then change the position of the TV series 536 to be positioned before the TV series 532 (e.g., by using directional arrows of a controller). This can cause the TV series 532 and a TV series 538 to each move one position to the left so that the TV series 536 can now occupy the space previously occupied by the TV series 532.

In some implementations, a message can be displayed in the favorites menu 530 to indicate to the user how to change the order of TV series displayed within the favorites menu 530. For example, the message “Press and hold Select to rearrange your favorites” can be displayed over the favorites menu 530 the first three times that a particular user enters the favorites menu. In some implementations, the displayed message can fade away after a given time period (e.g., 5 seconds).

In some implementations, in which the TV series shown in the favorites menu 530 are sorted by date, the TV series can be sorted with the TV series having unwatched or partially watched episodes (e.g., TV series having indicators) placed before TV series with no unwatched or partially watched episodes (e.g., TV series having no indicator, or having an indicator showing “0”). The TV series having some unwatched or partially watched episodes can be sorted with the TV series having the most recent (by episode date) unwatched or partially watched episode positioned first (upper left corner) followed by the TV series with the next most recent unwatched or partially watched episode positioned next, and so on for each subsequent TV series. TV series having no unwatched or partially watched episodes (e.g., no indicator) can be ordered in the order in which all episodes for the series were watched. In other words, when the last unwatched episode of a TV series is watched, that TV series is moved to the front of the section of TV series having no unwatched or partially watched episodes.

In some implementations, a user is allowed to specify a methodology that is to be used for sorting the TV series displayed by the favorites menu 530. For example, the user can select between sorting by date, sorting alphabetically, or a “sorting off” mode. The “sorting off” mode can sort TV series in the order in which they are added to the favorites menu 530 with newly favorite shows added to the end. In some implementations, the user is allowed to change the display order of shows in the “sorting off” mode as described above.

In some implementations, art work from a most recent season of a TV series can be displayed in the favorites menu, and a name of a TV series can be indicated when a TV series is selected or “hovered” over. For example, the TV series 540 indicates a TV series name of “House” when the TV series 540 is hovered over. Selecting an image representing a TV series within the favorites menu 530 can take the user to a TV show season screen to allow the user to select from episodes of the current or latest season of the TV show. In some implementations, selecting an image representing a TV series can cause a season screen for the most recently accessed season to be displayed.

For example, referring to FIG. 5C, a series screen 550 is displayed for the TV series 540′. The series screen 550 displays shortcuts 554, 556 pointing to episodes for the most recently accessed season of the TV series 540′. In some implementations, the most recently accessed TV episode 554 will be highlighted on the season screen 550. For example, if the most recently accessed episode was not completed, the most recently accessed episode can be highlighted in the season screen 550. In some implementations, the oldest unwatched or partially watched episode will be highlighted on the season screen 550. In some implementations, the episode directly following the most recently completed episode will be highlighted on the season screen 550.

In some implementations, when a TV episode is rented or purchased, the TV episode is displayed within the season screen 550 and indicated by an indicator (e.g. a blue dot) as being unwatched (e.g., new). The indicator can change when the episode is partially, but not fully watched. For example, a full blue dot 555 can indicate a completely unwatched episode 554, while a partially filled in blue dot 557 can indicate a partially watched, but not completed episode 556. In some implementations, once an episode is completed, the indicator disappears from the season screen 550.

In some implementations, a TV series screen can include an add-to-favorites control in order to allow the user to add the TV series to the favorites menu 530 depicted in FIG. 5B. For example, referring to FIG. 5C, the season screen 550 can include an add to favorites control 552. The user can select the add to favorites control 552 to cause the TV series 540′ to be added to the favorites menu 530.

In some implementations, a user can cause a context menu to appear for an episode displayed in the season screen 550. For example, the user can highlight an episode 554 and hold a select button to cause a context menu for the episode to appear. The context menu can include options to allow the user to mark an episode as watched, mark an episode as unwatched, mark an entire season as watched, or mark an entire season as unwatched. In some implementations, the context menu can also include a “cancel” option. In some implementations, the “mark episode as watched” option is only displayed if an indicator indicating that the episode is unwatched or only partially watched is present. In some implementations, the “mark episode as unwatched” option is only displayed if the episode does not include an indicator to indicate that the episode is unwatched or partially watched. In some implementations, the “mark entire season as watched” option is only displayed if at least one episode is indicated as unwatched or partially watched. In some implementations, the “mark entire season as unwatched” option is only displayed if at least one episode in the season is indicated as watched. In some implementations, some of the control options displayed in the context menu are only displayed if the show has been added to the favorites menu.

In some implementations, after a user has indicated that a show is a favorite show (e.g., added the show to the favorites menu 530), each subsequent episode that is added is indicated as unwatched (e.g., receives a blue dot indicator). In some implementations, this rule applies only to episodes that are a part of the current season or subsequent season from when the TV series was added to the favorites menu. In some implementations, episodes included in season prior to a current season when a show is indicated as a favorite are not automatically marked. In some implementations, the most recent episode of a TV series can be marked as unwatched if the episode is unwatched at the time that the TV series is added to the favorites menu (even though the date of the episode may precede the date that the show is added to the favorites menu). In some implementations, rented episodes that expire are not automatically marked.

In some implementations, a remove from favorites control can be provided to allow a user to remove one or more TV series from the favorites menu 530. The remove from favorites control can be included in the favorites menu 530, as part of a season screen, or as part of another menu screen. In some implementations, when an item is removed from the favorites menu 530, all automatically placed indicators for episodes associated with that item are removed. In some implementations, full and partial indicators for rented episodes that have not expired will remain associated with the episodes until the episodes expire.

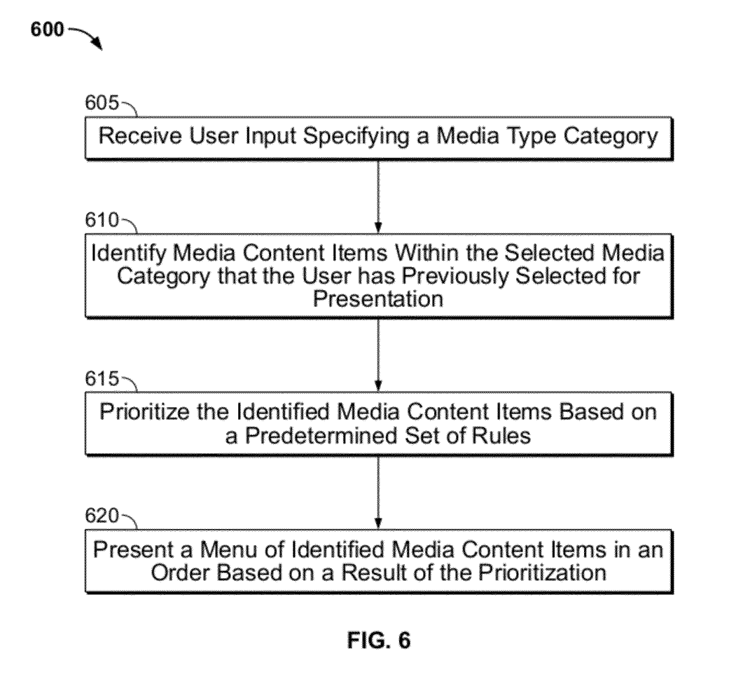

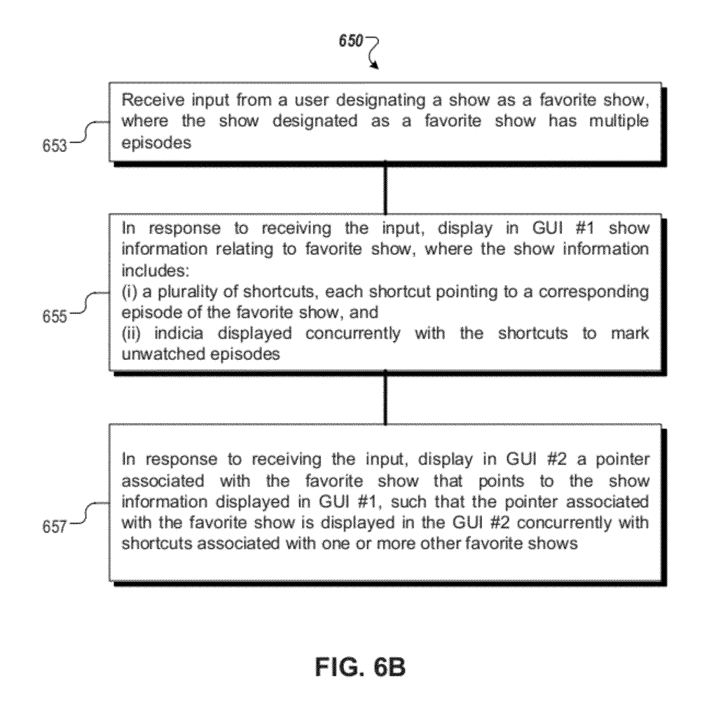

FIG. 6 is a flowchart of a process 600, performed for example by a media device, for generating a menu of available media items for presentation to a user. The process 600 is designed and intended to make an intelligent choice of available medium items, based on assumptions about which items of media content a typical user would likely be most interested in listening to and/or viewing next.

First, at 605, the process 600 receives user input specifying a media type category (e.g., Movies, TV Shows, Music, Photos, Podcasts, Internet). Next, at 610, the process 600 identifies media content items within the selected media category that the user previously has selected or otherwise marked for presentation (e.g., rented or purchased or downloaded from an online media store). Next, at 615, the process 600 prioritizes the identified media content items based on a predetermined set of rules, for example, the “Shelf Display Rules” set out above. Finally, at 620, the process presents to the user a menu of at least some of the identified media content items in an order based on a result of the prioritization.

For example, a menu screen having a shelf region that is divided into groupings with relative priorities, and media items displayed within those groupings, can be generated and displayed to the user. Process 600 can be executed and thus produce a new menu display each time the user selects another media type category. Although depicted in FIG. 6 in stepwise fashion, the steps are not necessarily order dependent and can be performed in a different order, or simultaneously, when feasible to achieve essentially the same result. For example, the media device could maintain a database of available media items, and further could maintain state tables (e.g., indicating a media item's state such as “new,” “watched,” “expired” and the like) corresponding to available media items, their respective media categories, their respective groupings, the relative priorities of those groupings, and/or the relative priorities media items within each grouping. And the media device could maintain and update the database and/or state tables each time the universe of available media changed (e.g., a new item of media content is added to the media device and/or an existing media content item is deleted, watched, or expires). In that case, the steps 610 (identifying media content items with the selected media category) and/or 615 (prioritize the identified media content items based on a predetermined set of rules) essentially would have been performed ahead of time—that is, before the selection of a new media category occurred in step 605.

FIG. 6B is a flowchart of another process 650 for generating a menu of favorite media items for presentation to a user. The process 600 can be performed by one or more processes executed on a computer system. For example, the process 650 can be implemented to generate the favorites menu 530 and the series menu 550 with which a user of a media device 100 can interact to browse and select episodes of a TV show for playback, as described above in connection with FIGS. 5B and 5C.

At 653, input from a user designating a show as a favorite show is received. As described above in this specification, a show (such as the show designated as the favorite show) can have multiple episodes.

In response to the received input, at 655, show information is displayed in a first graphical user interface (GUI). For example, the first graphical user interface can be implemented as the series menu 550 shown in FIG. 5C. The show information displayed in the first GUI relates to the favorite show and includes (i) a plurality of shortcuts, each shortcut pointing to a corresponding episode of the favorite show, and (ii) indicia displayed concurrently with the shortcuts to mark unwatched episodes. In the example implementation illustrated in FIG. 5C, a shortcut pointing to an episode can be represented in the first graphical user interface 550 by at least an image associated with the episode, e.g., 554 (or 556.) In addition, an indicium 555 (or 557), which is displayed in the first graphical user interface 550 concurrently with a shortcut 554 (or 556) pointing to an unwatched episode, at least partially overlaps the shortcut 554 (or 556). An indicium 555, which is concurrently displayed in the first graphical user interface 550 with a shortcut 554 pointing to an unwatched episode, can be filled with a color to indicate that the unwatched episode 554 is completely unwatched. Another indicium 557, which is concurrently displayed in the first graphical user interface 550 with a shortcut 556 pointing to an unwatched episode, can be partially filled with the color to indicate that the unwatched episode 556 is partially watched but not completed.

In some implementations, the input from the user can be received via the first graphical user interface. For example, the designation of a show 540′ as a favorite show can be received by the media device 100 via control 552 in the series menu 550.

Further in response to the received input, at 657, a pointer (or shortcut) associated with the favorite show is displayed in a second graphical user interface. For example, the second graphical user interface can be implemented as the favorites menu 530 shown in FIG. 5B. A pointer 540 displayed in the favorites menu 530 points to show information associated with a favorite show 540′ that is displayed in the first graphical user interface 550. Moreover, the pointer 540 is displayed in the second graphical user interface 530 concurrently with pointers 532, 536, 538 associated with respective other favorite shows.

Furthermore, the pointer 540 can be represented in the second graphical user interface 530 by at least an image associated with the favorite show 540′. In some implementations, the image associated with the favorite show 540′ can be an image corresponding to a first episode of the favorite show 540′. In other implementations, the image associated with the favorite show 540′ can be an image corresponding to a most recent episode of the favorite show 540′.

In some implementations, an indicator 542 associated with the pointer 540 is displayed in the second graphical user interface 530 concurrently with the pointer 540. The indicator 542 is configured to indicate a number of unwatched episodes from among the multiple episodes of the favorite show 540′. In some implementations, the indicator 542 displayed in the second graphical user interface 530 at least partially overlaps the pointer 540 that points to the show information associated with the favorite show 540′ displayed in the first graphical user interface 550.

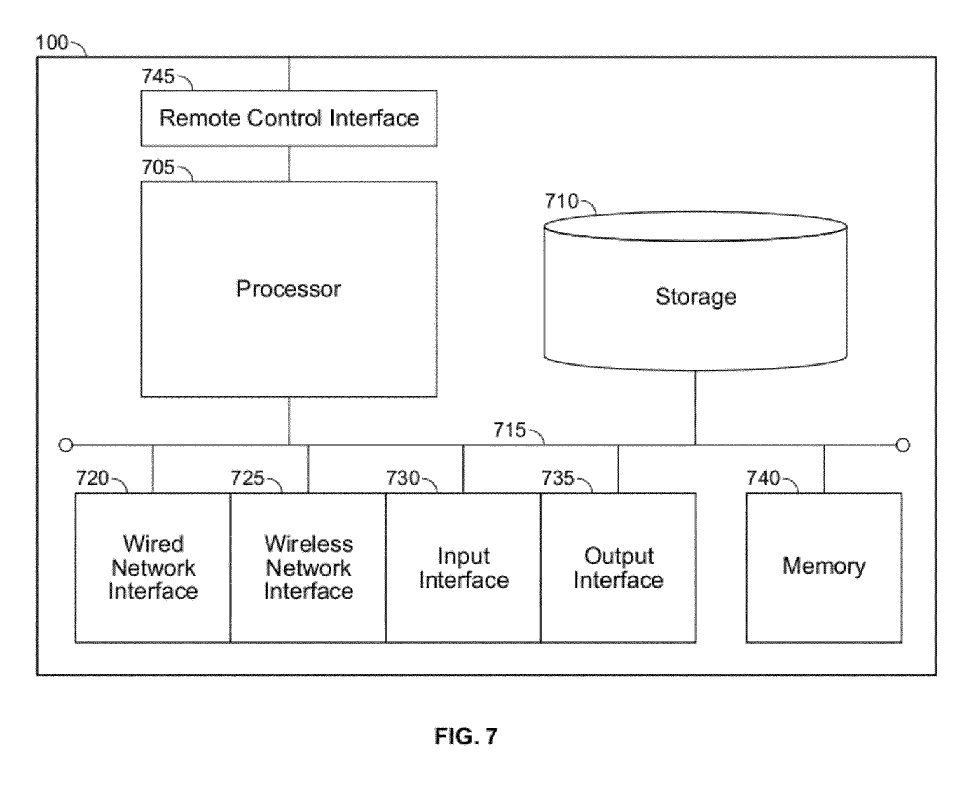

FIG. 7 depicts an exemplary architecture of the media client 100, which includes a processor 705 configured to control the operation of the media client 100. For example, the processor 705 can control communications with one or more media servers to receive media for playback. A media server can be any general purpose server that provides access to media content. The media can be received through push and/or pull operations, including through downloading and streaming. The processor 705 also can be configured to generate output signals for presentation, such as one or more streams representing media content or an interface for interacting with a user.

The media client 100 also includes a storage device 710 that can be configured to store information including media, configuration data, user preferences, and operating instructions. The storage device 710 can be any type of non-volatile storage, including a hard disk device or a solid-state drive. For example, media received from an external media server can be stored on the storage device 710. The received media thus can be locally accessed and processed. Further, configuration information, such as the resolution of a coupled display device or information identifying an associated media server, can be stored on the storage device 710. Additionally, the storage device 710 can include one or more sets of operating instructions that can be executed by the processor 705 to control operation of the media client 100. In an implementation, the storage device 710 further can be divided into a plurality of partitions, wherein each partition can be utilized to store one or more types of information. Additionally, each partition can have one or more access control provisions.

A communication bus 715 couples the processor 705 to the other components and interfaces included in the media client 100. The communication bus 715 can be configured to permit unidirectional and/or bidirectional communication between the components and interfaces. For example, the processor 705 can retrieve information from and transmit information to the storage device 710 over the communication bus 715. In an implementation, the communication bus 715 can be comprised of a plurality of busses, each of which couples at least one component or interface of the media client 100 with another component or interface.

The media client 100 also includes a plurality of input and output interfaces for communicating with other devices, including media servers and presentation devices. A wired network interface 720 and a wireless network interface 725 each can be configured to permit the media client 100 to transmit and receive information over a network, such as a local area network (LAN) or the Internet. Additionally, an input interface 730 can be configured to receive input from another device through a direct connection, such as a USB, eSATA or an IEEE 1394 connection.

Further, an output interface 735 can be configured to couple the media client 100 to one or more external devices, including a television, a monitor, an audio receiver, and one or more speakers. For example, the output interface 735 can include one or more of an optical audio interface, an RCA connector interface, a component video interface, and a High-Definition Multimedia Interface (HDMI). The output interface 735 also can be configured to provide one signal, such as an audio stream, to a first device and another signal, such as a video stream, to a second device. Further, a non-volatile memory 740, such as a read-only memory (ROM) also can be included in the media client 100. The non-volatile memory 740 can be used to store configuration data, additional instructions, such as one or more operating instructions, and values, such as one or more flags and counters. In an implementation, a random access memory (RAM) also can be included in the media client 100. The RAM can be used to store media content received in the media client 100, such as during playback or while the user has paused playback. Further, media content can be stored in the RAM whether or not the media content is stored on the storage device 710.

Additionally, the media client 100 can include a remote control interface 745 that can be configured to receive commands from one or more remote control devices (not pictured). The remote control interface 745 can receive the commands through wireless signals, such as infrared and radio frequency signals. The received commands can be utilized, such as by the processor 705, to control media playback or to configure the media client 100. In an implementation, the media client 100 can be configured to receive commands from a user through a touch screen interface. The media client 100 also can be configured to receive commands through one or more other input devices, including a keyboard, a keypad, a touch pad, a voice command system, and a mouse.

A number of implementations have been disclosed herein. Nevertheless, it will be understood that various modifications may be made without departing from the spirit and scope of the claims. Accordingly, other implementations are within the scope of the following claims.

What is claimed is:

1. A method performed by one or more processes executed on a computer system, the method comprising:
receiving input from a user designating a show as a favorite show, where the show designated as a favorite show has multiple episodes;
in response to receiving input,
displaying, in a first graphical user interface, show information relating to the favorite show, the show information including (i) a plurality of shortcuts, each shortcut pointing to a corresponding episode of the favorite show, and (ii) indicia displayed concurrently with the shortcuts to mark unwatched episodes; and
displaying, in a second graphical user interface, a pointer associated with the favorite show that points to the show information displayed in the first graphical user interface, the pointer associated with the favorite show being displayed in the second graphical user interface concurrently with shortcuts associated with one or more other favorite shows.

2. The method of claim 1, wherein the input from the user is received via the first graphical user interface.

3. The method of claim 1 further comprising
displaying, in the second graphical user interface concurrently with the pointer associated with the favorite show that points to the show information displayed in the first graphical user interface, an indicator associated with the pointer to indicate a number of unwatched episodes from among the multiple episodes of the favorite show.

4. The method of claim 3, wherein
an indicium, which is displayed in the first graphical user interface concurrently with a shortcut pointing to an unwatched episode, at least partially overlaps the shortcut, and
the indicator, which is displayed in the second graphical user interface concurrently with the pointer associated with the favorite show that points to the show information displayed in the first graphical user interface, at least partially overlaps the pointer.

5. The method of claim 1, wherein an indicium, which is concurrently displayed in the first graphical user interface with a shortcut pointing to an unwatched episode, is filled with a color to indicate that the unwatched episode is completely unwatched and is partially filled with the color to indicate that the unwatched episode is partially watched but not completed.

6. The method of claim 1, wherein a shortcut pointing to an episode is represented in the first graphical user interface by at least an image associated with the episode, and a pointer pointing to the show information is represented in the second graphical user interface by at least an image associated with the show.

7. The method of claim 6, wherein the image associated with the show, which is used to represent in the second graphical user interface the pointer pointing to the show information displayed in the first graphical user interface, is an image associated with one of a first or a most recent episode of the favorite show.

8. The method of claim 1 further comprising
receiving, in the second graphical user interface, user input indicating that the user wishes to change a current position of the pointer associated with the favorite show;
in response to said receiving the user input, jiggling the pointer associated with the favorite show at the current position to indicate to the user that the current position of the pointer can be changed;
receiving, in the second graphical user interface concurrently with said jiggling the pointer, another user input including at least an indication of a new position for the pointer associated with the favorite show; and
rearranging the pointer associated with the favorite show and the pointers associated with the other favorite shows in accordance with the received indication of the new position for the pointer associated with the favorite show.

9. A nonvolatile computer storage medium encoded with a computer program, the program comprising instructions that when executed by one or more computers cause the one or more computers to perform operations comprising:
receiving input from a user designating a show as a favorite show, where the show designated as a favorite show has multiple episodes;
in response to receiving input,
displaying, in a first graphical user interface, show information relating to the favorite show, the show information including (i) a plurality of shortcuts, each shortcut pointing to a corresponding episode of the favorite show, and (ii) indicia displayed concurrently with the shortcuts to mark unwatched episodes; and
displaying, in a second graphical user interface, a pointer associated with the favorite show that points to the show information displayed in the first graphical user interface, the pointer associated with the favorite show being displayed in the second graphical user interface concurrently with shortcuts associated with one or more other favorite shows.

10. The nonvolatile computer storage medium of claim 9, wherein the input from the user is received via the first graphical user interface.

11. The nonvolatile computer storage medium of claim 9, wherein the operations further comprise displaying, in the second graphical user interface concurrently with the pointer associated with the favorite show that points to the show information displayed in the first graphical user interface, an indicator associated with the pointer to indicate a number of unwatched episodes from among the multiple episodes of the favorite show.

12. The nonvolatile computer storage medium of claim 11, wherein
an indicium, which is displayed in the first graphical user interface concurrently with a shortcut pointing to an unwatched episode, at least partially overlaps the shortcut, and
the indicator, which is displayed in the second graphical user interface concurrently with the pointer associated with the favorite show that points to the show information displayed in the first graphical user interface, at least partially overlaps the pointer.

13. The nonvolatile computer storage medium of claim 9, wherein an indicium, which is concurrently displayed in the first graphical user interface with a shortcut pointing to an unwatched episode, is filled with a color to indicate that the unwatched episode is completely unwatched and is partially filled with the color to indicate that the unwatched episode is partially watched but not completed.

14. The nonvolatile computer storage medium of claim 9, wherein a shortcut pointing to an episode is represented in the first graphical user interface by at least an image associated with the episode, and a pointer pointing to the show information is represented in the second graphical user interface by at least an image associated with the show.

15. The nonvolatile computer storage medium of claim 14, wherein the image associated with the show, which is used to represent in the second graphical user interface the pointer pointing to the show information displayed in the first graphical user interface, is an image associated with one of a first or a most recent episode of the favorite show.

16. The nonvolatile computer storage medium of claim 9, wherein the operations further comprise:
receiving, in the second graphical user interface, user input indicating that the user wishes to change a current position of the pointer associated with the favorite show;
in response to said receiving the user input, jiggling the pointer associated with the favorite show at the current position to indicate to the user that the current position of the pointer can be changed;
receiving, in the second graphical user interface concurrently with said jiggling the pointer, another user input including at least an indication of a new position for the pointer associated with the favorite show; and
rearranging the pointer associated with the favorite show and the pointers associated with the other favorite shows in accordance with the received indication of the new position for the pointer associated with the favorite show.

17. A system comprising:
one or more computers and one or more storage devices storing instructions that are operable, when executed by the one or more computers, to cause the one or more computers to perform operations comprising:
receiving input from a user designating a show as a favorite show, where the show designated as a favorite show has multiple episodes;
in response to receiving input,
displaying, in a first graphical user interface, show information relating to the favorite show, the show information including (i) a plurality of shortcuts, each shortcut pointing to a corresponding episode of the favorite show, and (ii) indicia displayed concurrently with the shortcuts to mark unwatched episodes, and
displaying, in a second graphical user interface, a pointer associated with the favorite show that points to the show information displayed in the first graphical user interface, the pointer associated with the favorite show being displayed in the second graphical user interface concurrently with shortcuts associated with one or more other favorite shows.

18. The system of claim 17, wherein the input from the user is received via the first graphical user interface.

19. The system of claim 17, wherein the operations further comprise displaying, in the second graphical user interface concurrently with the pointer associated with the favorite show that points to the show information displayed in the first graphical user interface, an indicator associated with the pointer to indicate a number of unwatched episodes from among the multiple episodes of the favorite show.

20. The system of claim 19, wherein
an indicium, which is displayed in the first graphical user interface concurrently with a shortcut pointing to an unwatched episode, at least partially overlaps the shortcut, and
the indicator, which is displayed in the second graphical user interface concurrently with the pointer associated with the favorite show that points to the show information displayed in the first graphical user interface, at least partially overlaps the pointer.

21. The system of claim 17, wherein an indicium, which is concurrently displayed in the first graphical user interface with a shortcut pointing to an unwatched episode, is filled with a color to indicate that the unwatched episode is completely unwatched and is partially filled with the color to indicate that the unwatched episode is partially watched but not completed.

22. The system of claim 17, wherein
a shortcut pointing to an episode is represented in the first graphical user interface by at least an image associated with the episode, and
a pointer pointing to the show information is represented in the second graphical user interface by at least an image associated with the show, wherein the image associated with the show, which is used to represent in the second graphical user interface the pointer pointing to the show information displayed in the first graphical user interface, is an image associated with one of a first or a most recent episode of the favorite show.

23. The system of claim 17, wherein the operations further comprise:
receiving, in the second graphical user interface, user input indicating that the user wishes to change a current position of the pointer associated with the favorite show;
in response to said receiving the user input, jiggling the pointer associated with the favorite show at the current position to indicate to the user that the current position of the pointer can be changed;
receiving, in the second graphical user interface concurrently with said jiggling the pointer, another user input including at least an indication of a new position for the pointer associated with the favorite show; and
rearranging the pointer associated with the favorite show and the pointers associated with the other favorite shows in accordance with the received indication of the new position for the pointer associated with the favorite show.
